(19) United States
(12) Patent Application Publication
(10) Pub. No.: US 2015/0382093 A1
(43) Pub. Date: Dec. 31, 2015

(54) NOISE REDUCING MEMORY FOAM EARBUDS

(71) Applicant: Kendra Raechelle Jones, Belleville, IL (US)

(72) Inventor: Kendra Raechelle Jones, Belleville, IL (US)

(21) Appl. No.: 14/315,475

(22) Filed: Jun. 26, 2014

(51) Int. Cl. H04R 1/10; H04R 3/02; H04R 1/02

(52) U.S. Cl. CPC H04R 1/1016; H04R 1/02; H04R 3/02

(57) ABSTRACT

A noise reducing memory foam earbud comprising of a speaker assembly to receive electrical signals and to convert the electrical signals into audio signals, a housing, an elongated speaker canal tube built into the end of the housing and a memory foam fitted around the elongated speaker canal tube covering the whole body of the elongated speaker canal tube wherein the audio signals generated by the speaker assembly passes through the elongated speaker canal tube without any obstruction and when the noise reducing memory foam earbud is pushed into the ear canal of a user, said memory foam conforms to the irregular shape of ear canal and the noise reducing memory foam earbud gets firmly, securely and comfortably lodged into the ear canal thus reducing ingress of ambient noise into the ear canal and preventing leakage of audio signals generated by the speaker assembly out of the ear canal.

### FIELD OF THE INVENTION

The present invention generally relates to personal audio equipment. More particularly, the present invention relates to a set of lightweight and comfortable audio earbuds utilizing unique foam which provide high isolation from ambient surrounding noise.

### BACKGROUND OF THE INVENTION

Headphones are commonly used with a variety of electronic devices to provide mobile and/or personal access to audio content. For example, headphones can be used with music players. Headphones can also be used with cellular phones, personal digital assistants, computers, and most other types of electronic devices that produce audio signals. Headphones can reproduce sound with high fidelity so that the user can listen to the sound without disturbing people who are nearby. These headphones typically use small speakers that can render the sound.

There are many types of headphones in existence. Some headphones are supra-aural, meaning that they sit on top of the ear. These headphones are particularly susceptible to external noise because they do not enclose the ear. Other headphones are circum-aural. These headphones surround the ear to create a sound-isolated cavity that blocks out external noise. Circum-aural headphones can perform very well, but are bulky and inconvenient for portable applications. Another type of headphone is worn inside the ear. These headphones, also called earphones or earbuds, can sit outside the ear canal or be inserted into the ear canal. The latter type, often called canalphones or in-the-ear earbuds. Earbuds are miniature speakers that fit into the ears at the entry of the ear canal.

The distinction and advantages between headphones and earbuds has been repeatedly discussed by the users of each. Evidently, each one has its own strengths and weaknesses across a wide range of audio scenarios. Headphones may be good in a stationary, at home or in the studio environment. Headphone users typically may choose headphones for their better sound quality, noise-canceling capabilities and comfortable fit on the head/ears. Earbuds may come in handy when users are on-the-go, and need a quick and simple way of listening to audio that can be easily stored in their pocket or bag.

However, headphones and earbuds both have disadvantages of their own; traditional headphones have relatively large ear cups, headphones can be bulky, overly expensive, difficult to adjust to a perfect fit, and difficult to take on-the-go because of their larger size. On the other hand, earbuds may be uncomfortable, fall out of the ears, produce less quality sound, and cause more hearing loss/damage.

Drawbacks associated with earbuds are discussed in greater detail here. First, they are often ineffective at blocking out ambient noise and preventing leakage of the amplified sound into the surrounding area. Second, the position of the earbud in the ear is often not well controlled or aimed. The result is an erratically shaped passageway for the sound wave to travel as it leaves the speaker inside the earbud and makes its way into the ear canal. Abrupt changes in the direction or area of the passageway through which a sound pressure wave travels will alter both the pressure levels and the molecule motion within the pressure wave and distort the sound produced from the speaker. This type of interference of a sound pressure wave is often called “acoustical impedance” and is well known in the design of horns and wind instruments. Like electrical impedance often specified for speakers, acoustic impedance must be minimized for improved sound quality. The phenomenon of acoustical impedance is readily experienced by simply experimenting with different positions of the earbud within the ear. Third, many users find it difficult to keep the earbud retained in the ear. The cord extending from the earbud is easily snagged, and generally swings or bounces with activity. This movement, combined with perspiration in the ear, can often dislodge the earbud from the ear. Lastly, fitting the earbud to the ear needs to be accomplished without discomfort to the user. Some users feel discomfort due to the earbuds rigid circular shape which can create too much interference and pressure on the ear.

Prior art audio earbuds provide sound reproduction for the user but do not provide a substantial isolation from ambient audio levels external to the earbuds in a comfortable and lightweight package. That is, prior art earbuds often allow the user to hear not only the electronic audio information transmitted into the headphones but also the ambient external sound leaking into said electronic audio. The prior art earbuds that do provide isolation are heavy, uncomfortable, and bulky to the user.

Earbuds are used in a variety of environments. For example, earbuds may be plugged into computers or other electronic equipment that is powered from a wall outlet. Earbuds are also used in static-filled environments such as airplanes. Earbuds are sometimes handled roughly, so durability is a concern.

A number of attempts have been made to design earbuds and related accessories that address the basic problems of retention, the improvement of sound isolation and in ear comfort, but these designs are still significantly lacking in performance in one area or another. Prior art audio earbuds have drawbacks that cause inadequate retention of the ear piece to the ear canal. This is partly due to the fact that the ear canal has an irregular, non-circular cross section and that the axis or “path” of the ear canal is not linear but rather a circuitous path on its way to the ear drum. The cylindrical insert designs described do not conform well to the path of the ear canal due to the rigid structure on which they are mounted. These inserts conform less to the shape of the path of the ear canal but rather reshape the ear canal's path to become more the shape of the adapter. The result is a less than optimum fit within the ear canal area, uneven pressure exerted on the ear, and potential discomfort. In addition, because the contours of these elastomeric inserts do not match with the path of the ear canal, gaps can exist and the resiliency of the ear canal to return to its normal shape can act to push out and dislodge the earbud, especially with the help of perspiration and motion from exercise activity.

In addition to retaining the ear phone in the ear, it is also highly desirable to block out noise from the surrounding environment or from the wind for better audio clarity. This is commonly called “sound isolation” and involves significantly reducing or eliminating air gaps that allow the ingress of outside noise into the ear. Sound isolation also helps reduce the stray audio from the ear buds that may be heard by others, and less volume is needed to hear the audio since it is not competing with outside noise.

Unfortunately, due to the drawbacks noted above, existing ear phone products do not provide a comfortable product that is sufficiently retained in place on the ear during physical activities with a desired level of sound isolation.

The sound quality produced by a earbud is highly dependent on the design of its transducer(s). However, there are other parameters in the design of the in-the-ear earbuds, that affect sound quality as well. In general, sound waves originating from a transducer must propagate through a volume of air before reaching the listener's eardrums. During this time, the sound waves can be corrupted by a variety of factors, such as ambient noise and energy loss. Thus, there is a need in the art for earbuds that combats corruption of sound waves by a variety of factors, such as ambient noise and energy loss.

Noise cancellation systems are known, in which an electronic noise signal representing ambient noise is applied to a signal processing circuit, and the resulting processed noise signal is then applied to a speaker, in order to generate a sound signal. In order to achieve noise cancellation, the generated sound should approximate as closely as possible the inverse of the ambient noise, in terms of its amplitude and its phase.

However, noise cancellation systems are generally employed in applications where it is highly desirable to reduce power consumption. For example, portable music players and mobile phones have limited battery resources, and therefore efforts should be made in order to reduce the drain on these resources. Noise cancellation is one such drain, and therefore it is desirable to design an earbud that consumes no additional power and reduces noise as efficiently as possible.

Consequently, there exists in the art a long-felt need for earbuds that block out ambient noise and prevent leakage of the amplified sound into the surrounding area. There also exists in the art a long felt need for earbuds, the position of which are controlled in the ear for improved sound quality. There also exists in the art a long felt need for earbuds that retain in the ear. There also exists in the art a long felt need for earbuds that provide comfort to the user without creating interference and pressure on the ear. There also exists in the art a long felt need for earbuds that produce good quality sound, and cause no hearing loss/damage. There also exists in the art a long felt need for earbuds where less volume are needed to hear the audio. Additionally, there exists in the art a long felt need for earbuds that consumes no additional power and reduces noise as efficiently as possible. Finally, there is a long felt need in the art for earbuds that accomplish all of the foregoing objectives and that are relatively inexpensive to manufacture, safe and easy to use and are lightweight and not as cumbersome to wear or carry as headphones and not bulky to the user.

### OBJECTS OF THE INVENTION

An object of the invention is to provide an earbud that provides noise reduction by using a memory foam.

Another object of the invention is to provide an earbud that reduces noise without use of battery unlike prior art systems.

A still another object of the invention is to provide an earbud that prevents leakage of the amplified sound into the surrounding area.

Yet another object of the present invention is to provide an earbud that stay securely placed in the ear.

A still further object of the present invention is to provide an earbud that provides comfort to the user without creating interference and pressure on the ear.

A still another object of the invention is to provide an earbud that produce good quality sound, and cause no hearing loss/damage.

Yet another object of the present invention is to provide an earbud where less volume is needed to hear the audio.

A further object of the present invention is to provide an earbud that is portable and not bulky.

Yet another object of the invention is to provide an earbud the memory foam of which allows for a custom fit for each ear.

### BRIEF SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Accordingly, there is presented a noise reducing memory foam earbud. In a preferred embodiment of the present invention, a housing contains a speaker assembly known in the art, which is electrically connected to an audio player through wire bundle to receive electrical signals to convert it into audio signals. An elongated speaker canal tube is built into the end of the housing in such a way that the audio signals generated by the speaker passes through the elongated speaker canal tube without any obstruction. A memory foam is fitted around the elongated speaker canal tube covering the whole body of the elongated speaker canal tube.

The size of the memory foam fitted around the foam is such that it is slightly bigger than the size of the average human ear canal. While wearing the noise reducing memory foam earbud of the present invention, with the help of fingers the memory foam is squeezed by the user and the volume of the memory foam gets reduced along the axis of the elongated speaker canal tube. Memory foam has the property of slow recovery. That implies the squeezed memory foam remains in the squeezed condition for a certain period. In this condition of reduced volume of the memory foam, the noise reducing memory foam earbud is pushed into the ear canal by the user. When left at this position inside the ear canal the memory foam would try to regain its original shape and, in trying so, the memory foam conforms to the irregular shape of ear canal. This property of the memory foam ensures that, no matter whatever be the size and geometry of the ear canal, the memory foam would always conform to the ear canal shape and size of different users. The noise reducing memory foam earbud of the present invention is suitable for all kind of human ears. As the memory foam conforms to the irregular shape and size of ear canal, the noise reducing memory foam earbud gets firmly lodged into the ear canal until it is pulled away from outside. The firm but comfortable fit of the memory foam into ear canal ensures there is no or little space left between the noise reducing memory foam earbud and the ear canal for ingress of ambient noise into the ear canal and also for leakage of audio signals generated by the speaker of the noise reducing memory foam earbud out of the ear canal.

The noise reducing memory foam earbud of the present invention are portable and do not require batteries in order to operate. The noise reducing memory foam earbuds conform to the user's ears in a matter of seconds. The noise reducing memory foam earbuds of the present invention allow for a custom fit for each ear due to the presence of the memory foam and so provide a greatly increased level of comfort to the user. The noise reducing memory foam earbud of the present invention provide a high quality and clear sound without requiring a higher volume which may result in imperfections in music.

In another embodiment of the present invention, over the elongated speaker canal tube, a outer layer/cover made from a gel is used which provide a secure and comfortable fit of the noise reducing earbud to the user's ears.

In another embodiment of the present invention, noise reducing memory foam earbuds include a microphone/volume control button.

It would be obvious to those skilled in the art that the diameter and length of the elongated speaker canal tube used in the noise reducing memory foam earbud of the present invention can be of any suitable dimension.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF ACCOMPANYING DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a perspective view of noise reducing memory foam earbud in accordance with one embodiment of the present invention;

FIG. 2 illustrates another perspective view of noise reducing memory foam earbud in accordance with one embodiment of the present invention;

FIG. 3 illustrates a noise reducing memory foam earbud inserted into a human ear in accordance with one embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The embodiments described herein are directed to a pair of noise reducing memory foam earbuds which provide comfortable fit on the user's ears while isolating the user's ears from ambient noise and prevents leakage of the amplified sound into the surrounding area. These embodiments can provide better acoustic performance than the prior art types because the noise reducing memory foam earbuds of the present invention form an air tight seal in the ear canal to block out external noise. The noise reducing memory foam earbuds of the present invention fit snuggly within a user's ear canal, provide improved sound quality, retain in the ears, do not create interference and pressure on the ears, cause no hearing loss/damage, less volume is needed to hear the audio, consume no additional power and is lightweight.

Electronic devices can output audio content by conducting an electrical signal encoding the audio content through wire bundle to earbuds. The audio content may be encoded in the frequency, phase, and amplitude of the electrical signals. Wire bundle can comprise a group of wires that are bundled together and wrapped with insulation. Different wires in wire bundle can lead to each earbud. The signals carried to the left and right earbuds can also be different, for example to create stereophonic sound. Noise reducing memory foam earbud of the present invention can be inserted into the ear canal of the user. The functionality of earbud is elaborated below in conjunction with the figures.

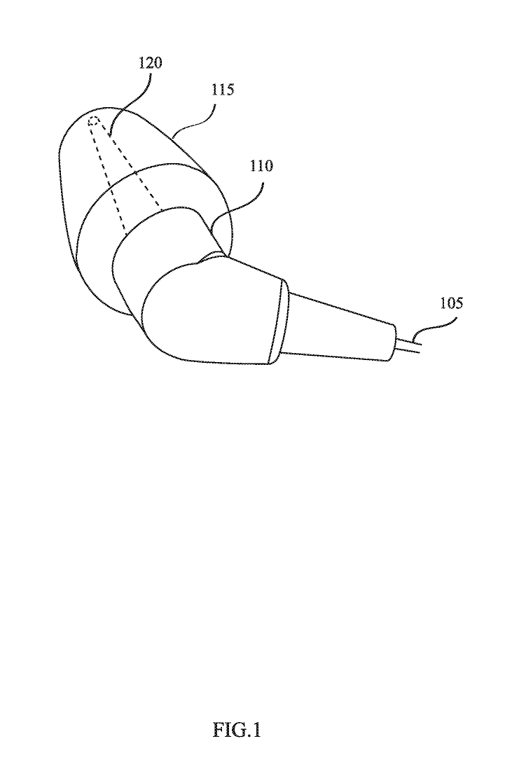

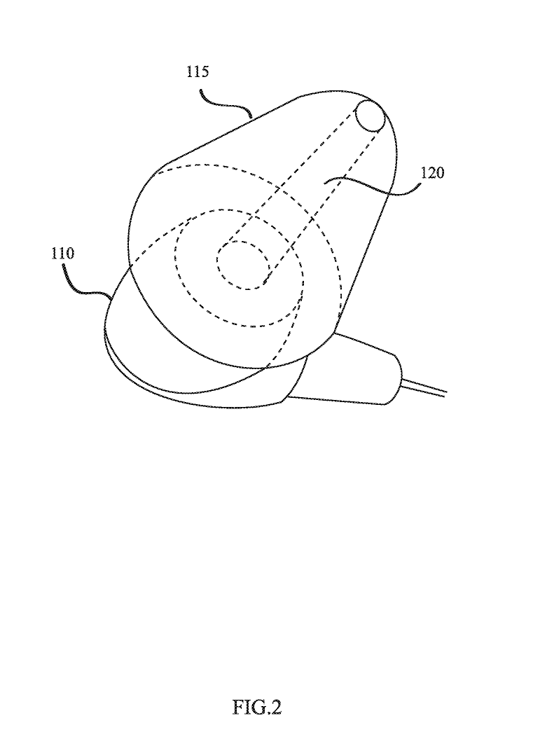

FIG. 1 and FIG. 2 show a noise reducing memory foam earbud in accordance with one embodiment of the present invention. In a preferred embodiment of the present invention, a housing 110 contains a speaker assembly (not shown in the drawings) known in the art, which is electrically connected to an audio player (not shown in the drawings) through wire bundle 105 to receive electrical signals to convert it into audio signals. An elongated speaker canal tube 120 is built into the end of the housing 110 in such a way that the audio signals generated by the speaker assembly passes through the elongated speaker canal tube 120 without any obstruction. The elongated speaker canal tube 120 is preferably made approximately 1.3 centimeter long and approximately 0.4 centimeter in out diameter. In one embodiment of the present invention, the diameter of the elongated speaker canal tube gradually decreases from the base to the open end. In another embodiment of the present invention, the diameter of the elongated speaker canal tube 120 remains constant through its length. A memory foam 115 is fitted around the elongated speaker canal tube 120 covering the whole body of the elongated speaker canal tube 120. In another preferred embodiment of the present invention the memory foam 115 covers the elongated speaker canal tube 120 up to its open end and a dust cap (not shown in the figures) is provided at the open end of the elongated speaker canal tube 120. The memory foam 115 is fitted around the elongated speaker canal tube 120 by means of adhesive or any other suitable means known in the art. Memory foam is a popular name of viscoelastic flexible polyurethane foam and its use in purposes other than the present use is known in the art.

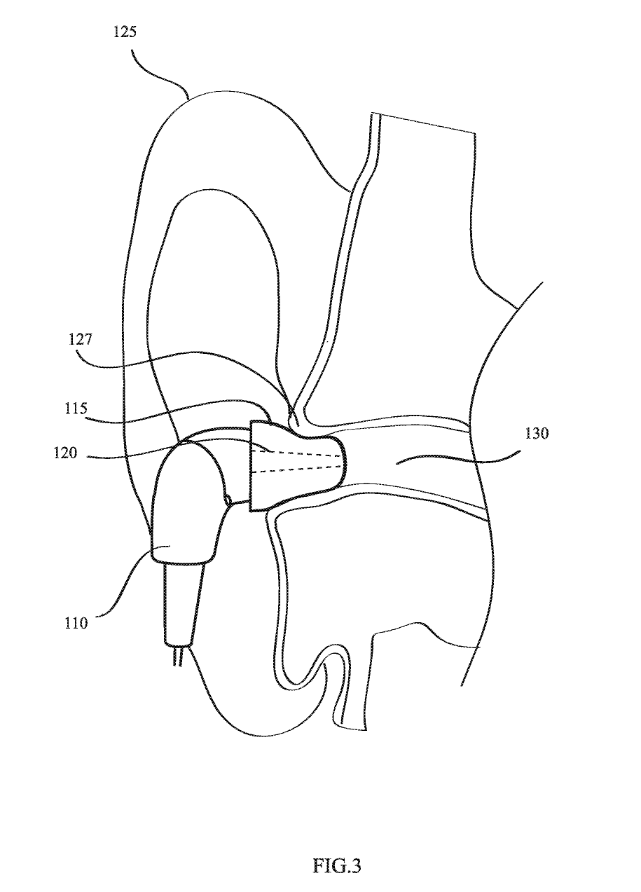

FIG. 3 shows a noise reducing memory foam earbud of the present invention fitted to a human ear 125. There are many different ear sizes and geometries. The ear canal is an irregularly shaped cylinder with a variable cross sectional area and a centerline that is not straight. Among the features identified in FIG. 3 is the entrance to the ear canal 127 and the main portion of the ear canal 130. In this specification the entrance to the ear canal 127 refers to the portion of the ear canal near the concha where the walls of the ear canal are substantially non parallel to the centerline of the ear canal. The size of the memory foam 115 fitted around the elongated speaker canal tube 120 is such that it is slightly bigger than the size of the average human ear canal 130. While wearing the noise reducing memory foam earbud of the present invention, with the help of fingers, the memory foam 115 is squeezed by the user and the volume of the memory foam 115 gets reduced along the axis of the elongated speaker canal tube 120. Memory foam has the property of slow recovery. That implies the squeezed memory foam remains in the squeezed condition for a certain period. In this condition of reduced volume of the memory foam 115, the noise reducing memory foam earbud is pushed into the ear canal 130 by the user. When left at this position inside the ear canal 130, the memory foam 115 would try to regain its original shape and, in trying so, the memory foam 115 conforms to the irregular shape of ear canal 130 as shown in FIG. 3. This property of the memory foam ensures that, no matter whatever be the size and geometry of the ear canal 130, the memory foam would always conform to the ear canal shape and size of different users. The noise reducing memory foam earbud of the present invention is suitable for all kind of human ears. As the memory foam 115 conforms to the irregular shape and size of ear canal 130, the noise reducing memory foam earbud gets firmly lodged into the ear canal 130 until it is pulled away from outside. The firm but comfortable fit of the memory foam 115 into ear canal 130 ensures there is no or little space left between the noise reducing memory foam earbud and the ear canal 130 either for ingress of ambient noise into the ear canal 130 or for leakage of audio signals generated by the speaker assembly of the noise reducing memory foam earbud out of the ear canal 130.

Noise reducing memory foam earbuds of the present invention can be used with any type of electronic device that produces compatible audio output signals. Noise reducing memory foam earbuds may be connected to an electronic device at an audio output port. Noise reducing memory foam earbuds may preferentially include two earbuds, one for each ear. In another embodiment of the present invention, noise reducing memory foam earbuds may include a microphone/volume control button. Each earbud employed in the noise reducing memory foam earbuds can function in a substantially similar fashion.

The elongated speaker canal tube can be manufactured from aluminum sheet or any other suitable material known in the art without affecting the overall scope of the invention. The body of the noise reducing memory foam earbuds can be manufactured from plastic or any other suitable material known in the art without affecting the overall scope of the invention.

In another embodiment of the present invention, over the elongated speaker canal tube, a outer layer/cover made from a gel is used in place of memory foam which provide a secure and comfortable fit of the noise reducing earbud to the user's ears.

It would be obvious to those skilled in the art that the diameter and length of the elongated speaker canal tube used in the noise reducing memory foam earbud of the present invention can be of any suitable dimension.

Having now described the preferred embodiments of the noise reducing memory foam earbud, its use and usefulness will now be described. The noise reducing memory foam earbuds of the present invention do not require batteries or noise reduction circuitry for operation as the noise reduction happens due to the use of memory foam and are thus inexpensive. The noise reducing memory foam earbuds of the present invention do not hurt as the memory foam conforms to the irregular shape and size of different ears. The noise reducing memory foam earbuds of the present invention are portable and as such allow for greater transportability by being small due to absence of any noise reduction circuitry while still providing quality sound and reducing surrounding noise. The noise reducing memory foam earbuds of the present invention are not bulky. The noise reducing memory foam earbuds of the present invention allow users the convenience of noise reduction without the burden of large bulky headphones. The noise reducing memory foam earbuds of the present invention costs much less than noise cancelling headphones and is more cost effective than getting other earbuds professionally molded to an individual. The noise reducing memory foam earbuds of the present invention provides quality sound because they reduce all unwanted noise, comfort because the memory foam allows the earbuds mold to each individuals ear, secure placement also because of the form fitting property of memory foam, and cost effective because they do not require batteries. Noise reduction is in effect with or without music and/or power source. Users can wear noise reducing memory foam earbuds while conducting various types of daily activity, including not just sitting calmly and listening to music, but also while walking, exercising vigorously, and talking on a telephone call.

Additionally, other variations are within the spirit of the present invention. Thus, while the invention is susceptible to various modifications and alternative constructions, a certain illustrated embodiment thereof is shown in the drawings and has been described above in detail.

It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A noise reducing memory foam earbud comprising:
a speaker assembly electrically connected to an audio player through a wire bundle to receive electrical signals and to convert said electrical signals into audio signals;
a housing for housing said speaker assembly;
an elongated speaker canal tube built into the end of said housing; and
a memory foam fitted around said elongated speaker canal tube covering the whole body of said elongated speaker canal tube;
wherein the audio signals generated by said speaker assembly passes through said elongated speaker canal tube without any obstruction and when said noise reducing memory foam earbud is pushed into the ear canal of a user, said memory foam conforms to the irregular shape of ear canal and said noise reducing memory foam earbud gets firmly, securely and comfortably lodged into the ear canal thus reducing ingress of ambient noise into the ear canal and preventing leakage of audio signals generated by said speaker assembly out of the ear canal.

2. The noise reducing memory foam earbud as in claim 1, wherein said noise reducing memory foam earbud comes in pair.

3. The noise reducing memory foam earbud as in claim 1, wherein said noise reducing memory foam earbud include a mic/volume control button.

4. The noise reducing memory foam earbud as in claim 2, wherein said each noise reducing memory foam earbud function in a substantially similar fashion.

5. The noise reducing memory foam earbud as in claim 1, wherein said noise reducing memory foam earbud when pushed into the ear canal of a user, said memory foam conforms to the irregular shape of ear canal no matter whatever be the size and geometry of the ear canal.

6. The noise reducing memory foam earbud as in claim 1, wherein there is no space left between said noise reducing memory foam earbud and the ear canal.

7. The noise reducing memory foam earbud as in claim 1, wherein noise reduction is achieved without the use of battery.

8. The noise reducing memory foam earbud as in claim 1, wherein said noise reducing memory foam earbud does not create interference and pressure on the ear.

9. The noise reducing memory foam earbud as in claim 1, wherein said noise reducing memory foam earbud produce good quality sound and cause no hearing loss/damage.

10. The noise reducing memory foam earbud as in claim 1, wherein less volume is needed to hear the audio.

11. The noise reducing memory foam earbud as in claim 1, wherein said noise reducing memory foam earbud is portable.

12. The noise reducing memory foam earbud as in claim 1, wherein said noise reducing memory foam earbud allows for a custom fit for each ear of said user.

13. The noise reducing memory foam earbud as in claim 1, wherein the body of said noise reducing memory foam earbuds is manufactured from plastic.

14. The noise reducing memory foam earbud as in claim 1, wherein the body of said noise reducing memory foam earbuds is manufactured from any suitable material.

15. The noise reducing memory foam earbud as in claim 1, wherein said elongated speaker canal tube is manufactured from aluminum sheet.

16. The noise reducing memory foam earbud as in claim 1, wherein said elongated speaker canal tube is manufactured from any suitable material.

17. The noise reducing memory foam earbud as in claim 1, wherein the diameter and length of said elongated speaker canal tube is of any suitable dimension.

18. The noise reducing memory foam earbud as in claim 1, wherein the outer layer/cover made from a gel is placed over said elongated speaker canal tube.
